(19) United States
(12) Patent Application Publication
(10) Pub. No.: US 2023/0343083 A1
(43) Pub. Date: Oct. 26, 2023

(54) Training Method for Multi-Task Recognition Network Based on End-To-End, Prediction Method for Road Targets and Target Behaviors, Computer-Readable Storage Media, and Computer Device

(71) Applicant: Shenzhen Guodong Technology Company Limited, Shenzhen (CN)

(72) Inventor: Jianxiong XIAO, Shenzhen (CN)

(73) Assignee: Shenzhen Guodong Technology Company Limited, Shenzhen (CN)

(21) Appl. No.: 18/302,815

(22) Filed: Apr. 19, 2023

(30) Foreign Application Priority Data
Apr. 21, 2022 (CN) 202210423233.7

(51) Int. Cl. G06V 10/82; G06V 10/70

(52) U.S. Cl. CPC G06V 10/82; G06V 10/87

(57) ABSTRACT

A training method for a multi-task recognition network based on end-to-end provided includes: obtaining a plurality of data and location information by a plurality of different sensors located at different positions of an autonomous driving vehicle; inputting the plurality of data into a corresponding data processing network to obtain a plurality of first samples; inputting the first samples into a feature extraction network to obtain a plurality of first-sample features; inputting the plurality of the first-sample features and the plurality of location information into a feature recognition network to obtain a plurality of second samples; training an initial multi-task recognition network based on the second samples to obtain a target multi-task recognition network with recognition and prediction functions. A prediction method for road targets and target behaviors, a computer-readable storage media, and a computer device are also provided.

### CROSS REFERENCE TO RELATED APPLICATION

This non-provisional patent application claims priority under 35 U. S. C. § 119 from Chinese Patent Application No. 202210423233.7 filed on Apr. 21, 2022, the entire content of which is incorporated herein by reference.

### TECHNICAL FIELD

The disclosure relates to autonomous driving technologies, in particular to a training method for a multi-task recognition network based on end-to-end, a prediction method for road targets and target behaviors, a computer-readable storage media, and a computer device.

### BACKGROUND

With the development of science and technology, autonomous driving vehicles have appeared more and more in people's daily life. The object of autonomous driving is to go from driver assistance to ultimately driver replacement, and build a safe, compliant and convenient personal autonomous transportation system. In existing autonomous driving systems, autonomous driving vehicles for achieving complete autonomous driving is first to be able to accurately identify objects on roads and accurately predict trajectories of objects on the roads. In existing autonomous driving systems, pre-trained deep-learning networks are applied to recognize objects on roads and predict a path of objects on roads.

However, in existing autonomous driving systems, training samples configured to train the deep-learning networks need to be marked manually. It is time-consuming and extremely costly to obtain training samples. And when autonomous driving vehicles encounter new scenarios, it takes a lot of time to screen and label the training samples to obtain new training samples. After the new training samples are obtained, it also takes a long time to train a new recognition model to recognize objects in new scenes. As a result, it is impossible to provide the latest model for autonomous driving vehicles in time.

Therefore, there is a improve room for quickly and accurately transforming the data covered in the new scenes encountered by autonomous driving vehicles into the training samples and using the training samples to train neural networks that can recognize target objects in the new scenes.

### SUMMARY

Disclosed are a training method for a multi-task recognition network based on end-to-end, a prediction method for road targets and target behaviors, a computer-readable storage media, and a computer device. The training method for the multi-task recognition network based on end-to-end can quickly and accurately transform data covered in new scenes encountered by autonomous driving vehicles into training samples and use the training samples to train neural networks that can recognize target objects in the new scenes, so that autonomous driving vehicles can quickly adapt to a new driving environment and improve an ability of autonomous driving vehicles to adapt to a new environment.

In a first aspect, the training method for the multi-task recognition network based on end-to-end provided includes steps of: obtaining a plurality of data and location information by a plurality of different sensors, the plurality of different sensors comprising a 2D camera, a 3D camera, a radar, and/or a lidar located at different positions of an autonomous driving vehicle; inputting the plurality of data into a corresponding data processing network to obtain a plurality of first samples, each of the first samples comprising a 2D image sample, a 3D image sample, a radar bird's-eye-view sample, and/or a lidar bird's-eye-view sample; inputting the first samples into a feature extraction network to obtain a plurality of first-sample features; inputting the plurality of the first-sample features and the plurality of location information into a feature recognition network to obtain a plurality of second samples, each of the second samples comprising a target object, and a motion trajectory of the target object at a current position contained in the plurality of data; training an initial multi-task recognition network based on the second samples to obtain a target multi-task recognition network with recognition and prediction functions.

In a second aspect, the prediction method for road targets and target behaviors provided includes steps of: obtaining the plurality of data and location information by the plurality of different sensors, the plurality of different sensors comprising the 2D camera, the 3D camera, the radar, and/or the lidar located at different positions of the autonomous driving vehicle; inputting the plurality of data and location information into the target multi-task recognition network of the training method for the multi-task recognition network based on end-to-end to obtain the target object, and the motion trajectory of the target object contained in the plurality of data.

In a third aspect, the computer-readable storage media is provided. The computer-readable storage media stores a program instruction that can be loaded and executed by a processor to perform the training method for the multi-task recognition network based on end-to-end. The training method for the multi-task recognition network based on end-to-end includes steps of: obtaining the plurality of data and location information by the plurality of different sensors, the plurality of different sensors comprising the 2D camera, the 3D camera, the radar, and/or the lidar located at different positions of the autonomous driving vehicle; inputting the plurality of data into the corresponding data processing network to obtain the plurality of the first samples, each of the first samples comprising the 2D image sample, the 3D image sample, the radar bird's-eye-view sample, and/or the lidar bird's-eye-view sample; inputting the first samples into the feature extraction network to obtain the plurality of first-sample features; inputting the plurality of the first-sample features and the plurality of location information into the feature recognition network to obtain the plurality of the second samples, each of the second samples comprising the target object, and the motion trajectory of the target object at the current position contained in the plurality of data; and training the initial multi-task recognition network based on the second samples to obtain the target multi-task recognition network with recognition and prediction functions.

In a fourth aspect, the computer device is provided. The computer device includes a memory and a processor. The memory is configured to store a program instruction. The processor is configured to execute the program instruction to perform the training method for the multi-task recognition network based on end-to-end. The training method for the multi-task recognition network based on end-to-end includes steps of: obtaining computer device plurality of data and location information by the plurality of different sensors, the plurality of different sensors comprising the 2D camera, the 3D camera, the radar, and/or the lidar located at different positions of the autonomous driving vehicle; inputting the plurality of data into the corresponding data processing network to obtain the plurality of the first samples, each of the first samples comprising the 2D image sample, the 3D image sample, the radar bird's-eye-view sample, and/or the lidar bird's-eye-view sample; inputting the first samples into the feature extraction network to obtain the plurality of first-sample features; inputting the plurality of the first-sample features and the plurality of location information into the feature recognition network to obtain the plurality of the second samples, each of the second samples comprising the target object, and the motion trajectory of the target object at the current position contained in the plurality of data; and training the initial multi-task recognition network based on the second samples to obtain the target multi-task recognition network with recognition and prediction functions.

The training method for the multi-task recognition network based on end-to-end can quickly and accurately transform the data covered in the new scenes encountered by autonomous driving vehicles into the training samples, and use the training samples to train neural networks that can recognize target objects in the new scenes, which makes that autonomous driving vehicles can quickly adapt to the new driving environment and improve the ability of autonomous driving vehicles to adapt to the new environment.

### BRIEF DESCRIPTION OF THE DRAWINGS

In order to illustrate the technical solution in the embodiments of the disclosure or the prior art more clearly, a brief description of drawings required in the embodiments or the prior art is given below. Obviously, the drawings described below are only some of the embodiments of the disclosure. For ordinary technicians in this field, other drawings can be obtained according to the structures shown in these drawings without any creative effort.

FIG. 1 illustrates a flow diagram of a training method for a multi-task recognition network based on end-to-end.

FIG. 2 illustrates a first sub-flow diagram of a training method for a multi-task recognition network based on end-to-end.

FIG. 3 illustrates a second sub-flow diagram of a training method for a multi-task recognition network based on end-to-end.

FIG. 4 illustrates a first schematic diagram of a network structure of a training method of multi-task recognition network.

FIG. 5 illustrates a second schematic diagram of a network structure of a training method of multi-task recognition network.

FIG. 6 illustrates a third schematic diagram of a network structure of a training method of multi-task recognition network.

FIG. 7 illustrates a flow diagram of a prediction method for road targets and target behaviors.

FIG. 8 illustrates a schematic diagram of the internal structure of a computer device.

The realization of the purpose, functional characteristics and advantages of the disclosure will be further explained by referring to the attached drawings.

### DETAILED DESCRIPTION OF THE EMBODIMENTS

In order to make the purpose, technical solution and advantages of the invention more clearly, the invention is further described in detail in combination with the drawings and embodiments. It is understood that the specific embodiments described herein are used only to explain the invention and are not configured to define it. On the basis of the embodiments in the invention, all other embodiments obtained by ordinary technicians in this field without any creative effort are covered by the protection of the invention.

The terms “first”, “second”, “third”, “fourth”, if any, in the specification, claims and drawings of this application are configured to distinguish similar objects but need not be configured to describe any particular order or sequence of priorities. It should be understood that the data used here are interchangeable where appropriate, in other words, the embodiments described can be implemented in order other than what is illustrated or described here. In addition, the terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that the references to “first”, “second”, etc. in the invention are for descriptive purpose only and neither be construed or implied the relative importance nor indicated as implying the number of technical features. Thus, feature defined as “first” or “second” can explicitly or implicitly include one or more such features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the invention.

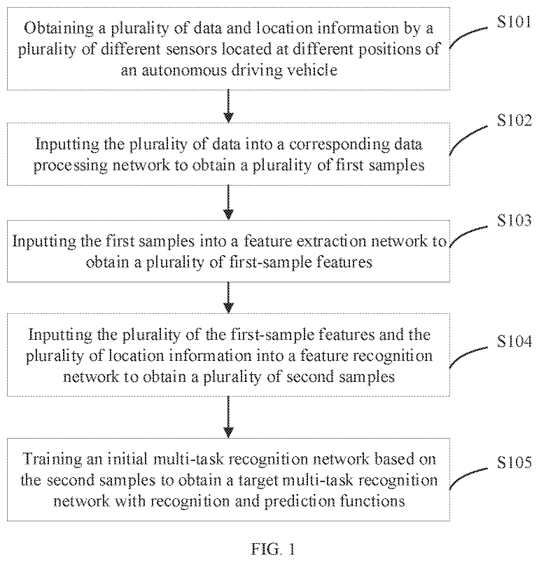

Referring to FIG. 1, a flow diagram of a training method for a multi-task recognition network based on end-to-end is illustrated. The training method for a multi-task recognition network based on end-to-end includes follows steps S101-S104.

At the step S101, a plurality of data and location information are obtained by a plurality of different sensors located at different positions of an autonomous driving vehicle.

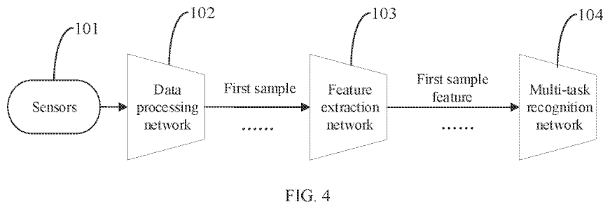

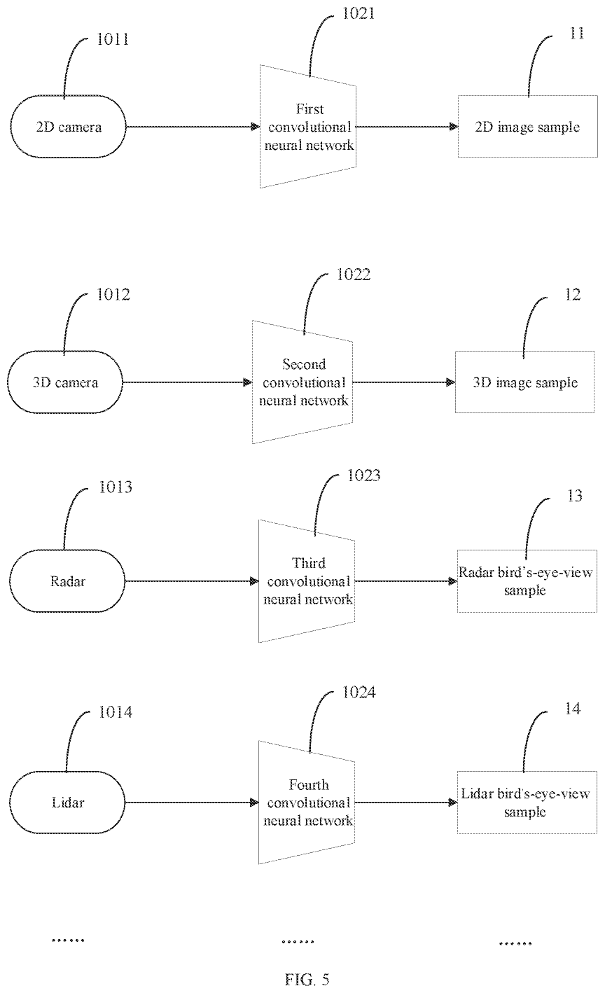

Referring to FIG. 4 and FIG. 5, a first schematic diagram of a network structure of a training method of multi-task recognition network is illustrated, and a second schematic diagram of a network structure of a training method of multi-task recognition network is illustrated.

In this embodiment, the different sensors 101 includes one or more 2D cameras 1011, one or more 3D cameras 1012, one or more radars 1013 and/or one or more lidars 1014. The different sensors 101 further includes one or more 4D millimeter-wave radars (not shown). A plurality of image data or point cloud data from different perspectives are obtained via one or more sample sensors of the different sensors 101 located at different positions of a main body of the autonomous driving vehicle. Specifically, input of sensors for autonomous driving vehicles is selectable. The autonomous driving vehicles can either select all of sensors to acquire data, or select any one or more of sensors to acquire data.

At the step S102, the plurality of data is input into a corresponding data processing network to obtain a plurality of first samples. The first samples includes one or more 2D image samples 11, one or more 3D image samples 12, one or more radar bird's-eye-view samples 13 and/or one or more lidar bird's-eye-view samples 14. Specifically, the data processing network 102 is configured to process the plurality of data into samples that can be recognized and used by a next deep learning network. Details of the step S102 will described in follow steps S1021-S1024.

In this embodiment, the training method for the multi-task recognition network based on end-to-end can be achieved by using a plurality of different deep learning networks with different functions. The plurality of different deep learning networks with different functions form a fully end-to-end learnable and trainable system. Due to the deep learning networks, the training method for the multi-task recognition network based on end-to-end can directly transform the plurality of data obtained by sensors into the input of the next deep learning network or training samples, without manual screening and constructions of training samples. Furthermore, the difference between the training method for the multi-task recognition network based on end-to-end and the traditional method using the deep learning networks is that the training method for the multi-task recognition network based on end-to-end completely realizes interactions of the data between the deep learning networks. There is no need to add other program codes to connect the plurality of deep learning networks to each other to become upstream and downstream. Schemes described above make full use of deep learning networks to process the data to obtain samples, and does not need to export, process and label the data additionally. Schemes described above also reduce processing steps and computing power of original data, thus speeding up the processing speed of the original data, improving the utilization rate of the data generated by the deep learning networks and saving a lot of labor costs.

At the step S103, the first samples are input into a feature extraction network to obtain a plurality of first-sample features.

In this embodiment, the feature extraction network 103 is a transformer neural network, a core module of which is a multi-head self-attention module, and the transformer neural network realizes the extraction of low-order and high-order cross information of input features by stacking multilayer multi-head self-attention modules. Specifically, the first-sample features may be the features of different autonomous driving vehicles on roads.

At the step S104, the plurality of the first-sample features and the location information are input into a feature recognition network to obtain a plurality of second samples. The second samples includes one or more target objects, and motion trajectories of the target objects at a current position contained in the plurality of data. The plurality of the first-sample features and the plurality of location information are input into the feature recognition network to obtain the plurality of second samples.

In this embodiment, the feature recognition network is a recurrent neural network (RNN), which is a recursive neural network that takes data of one or more sequences as input, recurses in evolution directions of the sequences, and connects all nodes by a chain.

In this embodiment, the feature recognition network is a spacial recurrent neural network (Spacial RNN). Each cell of the Spacial RNNs is an RNN. Different RNNs are used to extract different kinds of the sample features. Details of the step S104 will described in follow steps S1041-S1043.

At the step S105, an initial multi-task recognition network based on the second samples is trained to obtain a target multi-task recognition network with recognition and prediction functions.

In this embodiment, the initial multi-task recognition network 104 is a multilayer perceptrons (MLP). The MLP is a logistic regression classifier. Specifically, the MLP transforms data input with a learned nonlinear transformation, and then maps the data into a linearly separable space, which is called a hidden layer. The MLP with the single hidden layer is sufficient to be a universal approximator. A neural network with multi-task recognition is built by using such hidden layers. Specifically, the multi-task recognition network obtained by the training method for the multi-task recognition network based on end-to-end can recognize the types of objects on roads. In some cases, the multi-task recognition network obtained by the training method for the multi-task recognition network based on end-to-end can predict driving trajectories of objects on roads. In other cases, the multi-task recognition network obtained by the training method for the multi-task recognition network based on end-to-end recognizes the types of objects on roads and predicts the driving trajectories of objects on roads. The output of the multi-task recognition network can be set according to actual needs.

In this embodiment, the multi-task recognition network can set an output according to actual needs to increase application scenarios. The multi-task recognition network can also save hardware memory resources of the autonomous driving vehicles while handling multiple tasks, which makes that the autonomous driving vehicles have more hardware resources to process other events and improve overall performance.

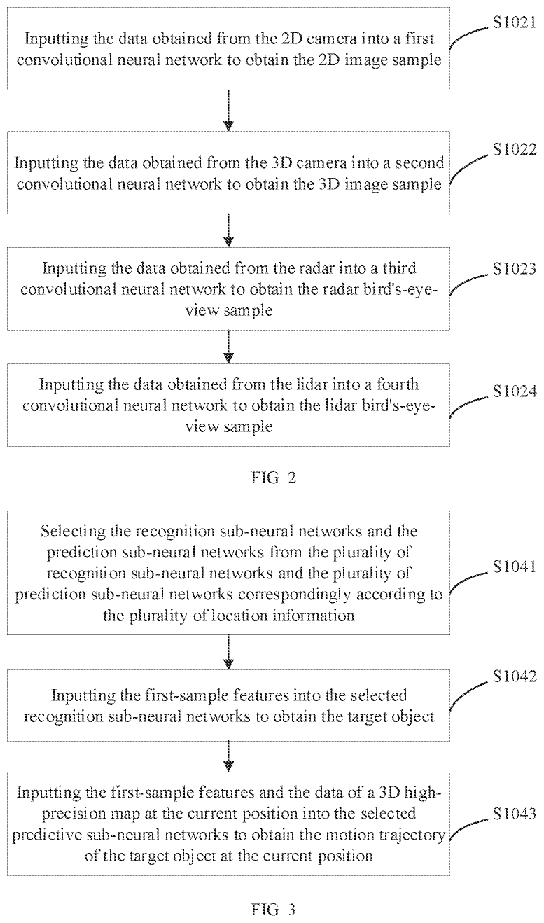

Referring to FIG. 2, a first sub-flow diagram of a training method for a multi-task recognition network based on end-to-end is illustrated. The plurality of data is input into the corresponding data processing network to obtain the plurality of the first samples includes follows steps S1021-S1024.

At the step S1021, the data obtained from the 2D cameras is input into a first convolutional neural network to obtain the 2D image samples.

Specifically, referring to FIG. 5, the first convolutional neural network 1021 is a convolutional neural network that has been trained to convert images or video data captured by the 2D cameras 1011 into one or more 2D images.

At the step S1022, the data obtained from the 3D cameras is input into a second convolutional neural network to obtain the 3D image samples.

Specifically, referring to FIG. 5, the second convolutional neural network is a convolutional neural network that has been trained to convert images or video data captured by the 3D cameras 1012 into one or more 3D images.

At the step S1023, the data obtained from the radars is input into a third convolutional neural network to obtain the radar bird's-eye-view samples.

Specifically, referring to FIG. 5, the third convolutional neural network is a convolutional neural network that has been trained to convert point cloud data acquired by the radars 1013 into bird's-eye-view samples.

At the step S1024, the data obtained from the lidars is input into a fourth convolutional neural network to obtain the lidar bird's-eye-view samples.

Specifically, referring to FIG. 5, the fourth convolutional neural network is a convolutional neural network that has been trained to convert point cloud data acquired by the lidars 1014 into bird's-eye-view samples.

In this embodiment, the trained convolutional neural networks are configured to process the plurality of data obtained by the sensors, which effectively utilizes existing convolutional neural networks and improves the utilization rate of the convolutional neural networks.

Referring to FIG. 3, a second sub-flow diagram of a training method for a multi-task recognition network based on end-to-end is illustrated.

At the step S104, the plurality of the first-sample features and the location information are input into the feature recognition network to obtain the plurality of second samples. The feature recognition network includes a plurality of recognition sub-neural networks and a plurality of prediction sub-neural networks. The plurality of the first-sample features and the location information are input into the feature recognition network to obtain the plurality of second samples includes follows steps S1041-S1043.

At the step S1041, the recognition sub-neural networks and the prediction sub-neural networks are selected from the plurality of recognition sub-neural networks and the plurality of prediction sub-neural networks correspondingly according to the plurality of location information.

In this embodiment, the plurality of location information is obtained by an inertial measurement unit (IMU), a GPS, lidars, cameras and other sensors located at the autonomous driving vehicles. For example, when the autonomous driving vehicles confirm that the autonomous driving vehicles are driving on common roads according to positioning information of GPS, the autonomous driving vehicles select recognition sub-neural networks which is responsible for road targets recognition to process one or more samples among the 2D image samples 11, the 3D image samples 12, the radar bird's-eye-view samples 13 and the lidar bird's-eye-view samples 14. Because the environment of the common roads of the autonomous driving vehicles does not change in a short period of time, and the autonomous driving vehicles encountered by the autonomous driving vehicles on the common roads are updated every day, only new autonomous driving vehicles need to be continuously identified on the common roads frequently traveled by the autonomous driving vehicles to provide new autonomous-driving-vehicle samples for the multi-task recognition network.

In this embodiment, different recognition sub-neural networks are enabled to process information according to different environments, which simplifies calculation rules and improves overall efficiency of autonomous driving systems.

At the step S1042, the first-sample features are input into the selected recognition sub-neural networks to obtain the target object.

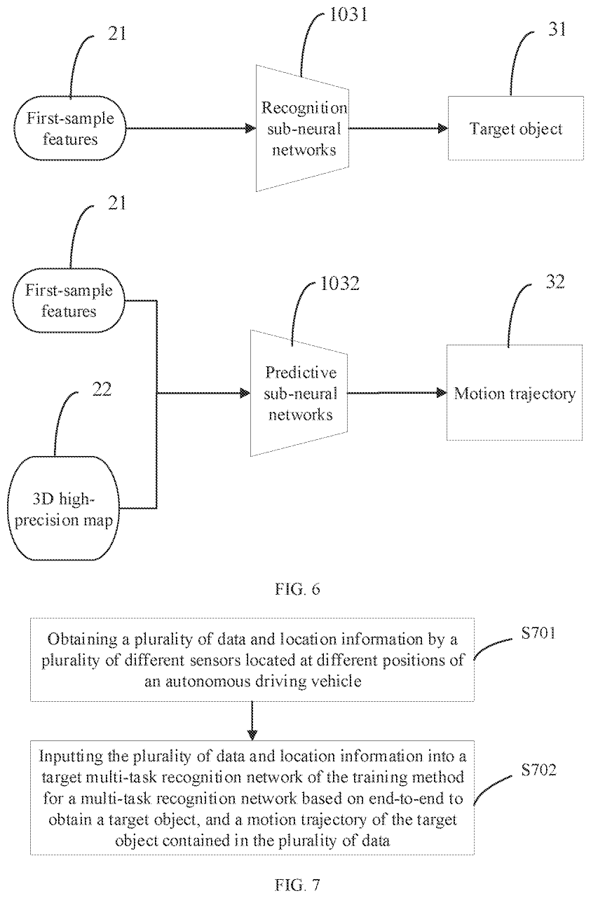

Referring to FIG. 6, input the first-sample features 21 into the recognition sub-neural networks 1031 to obtain the target objects 31.

At the step S1043, the first-sample features and the data of a 3D high-precision map at the current position are input into the selected predictive sub-neural networks to obtain the motion trajectory of the target object at the current position.

Referring to FIG. 6, input the first-sample features 21 and the data of the 3D high-precision map 22 at the current position into the selected predictive sub-neural networks 1032 to obtain the motion trajectories 32 of the target objects at the current position. Specifically, when the autonomous driving vehicles confirm that the autonomous driving vehicles are driving on new road sections according to the positioning information of the GPS, the autonomous driving vehicles select the plurality of recognition sub-neural networks and the plurality of prediction sub-neural networks which are responsible for the road targets recognition to process the 2D image samples 11, the 3D image samples 12, the radar bird's-eye-view samples 13 and/or the lidar bird's-eye-view samples 14. When roads of the autonomous driving vehicles are new, the autonomous driving vehicles not only need to obtain the recognition results of objects on roads, but also need to sample the surrounding environment. At the same time, the autonomous driving vehicles also need to combine a plurality of environmental data provided by the 3D high-precision map to confirm a current driving environment, and then accurately predict the motion trajectories of the surrounding objects according to the current driving environment. Therefore, when the autonomous driving vehicles drive on new roads, it not only needs to continuously identify the new autonomous driving vehicles but also needs to predict the driving trajectories of the autonomous driving vehicles according to the environment to provide the new autonomous-driving-vehicle samples and a plurality of driving-trajectory-prediction samples for the multi-task recognition network.

Referring to FIG. 7, a flow diagram of a prediction method for road targets and target behaviors is illustrated. The prediction method for road targets and target behaviors includes follows steps S701-S702.

At the step S701, the plurality of data and location information are obtained by the plurality of different sensors located at the different positions of the autonomous driving vehicles. The different sensor includes the 2D cameras, the 3D cameras, the radars, and/or the lidars. The different sensors further includes the 4D millimeter-wave radars. The image data or the point cloud data from different perspectives can be obtained through the sample sensors located at different positions of the autonomous driving vehicles. Specifically, the input of the sensors for the autonomous driving vehicles is selectable. The autonomous driving vehicles can either select all of the sensors to acquire data, or select any one or more of the sensors to acquire data.

At the step S702, the plurality of data and location information are input into the target multi-task recognition network of the training method for the multi-task recognition network based on end-to-end to obtain the target objects, and the motion trajectories of the target objects contained in the plurality of data.

A computer-readable storage media is also provided. The computer-readable storage media stores a program instruction that can be loaded and executed by a processor to perform the training method for the multi-task recognition network based on end-to-end. In particular, the technical solution of the present invention, in essence, or the part contributing to the prior art or all or part of the technical solution, may be embodied in the form of a software product stored in the computer-readable storage media including instructions for making a computer device, for example, a personal computer, a server, or a network device, etc., performs all or part of the steps of the methods of each embodiment of the invention. The computer-readable storage media include a U disk, a mobile hard disk, a read-only memory (ROM), a random access memory (RAM), a disk or an optical disc and other media that can store the program instruction. Since the computer-readable storage media adopts all the technical solutions of all the above embodiments, it has at least all the beneficial effects brought about by the technical solutions of the above embodiments, which are not repeated here.

A computer device is also provided. The computer device 900 includes, at a minimum, a memory 901 and a processor 902. The memory 901 is configured to store a program instruction. The processor 902 is configured to execute the program instruction to perform a training method for a multi-task recognition network based on end-to-end.

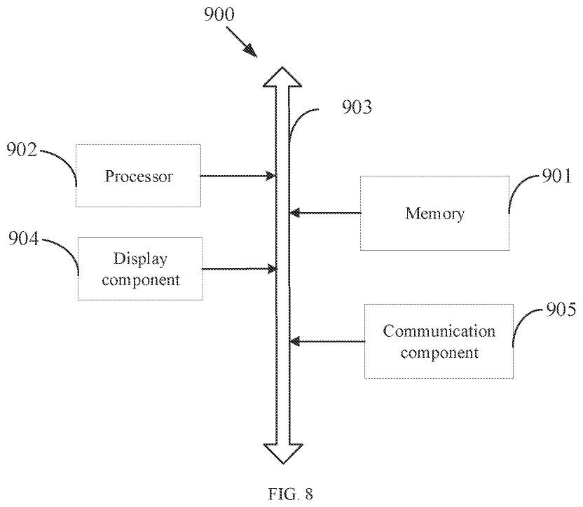

Referring to FIG. 8, a schematic diagram of the internal structure of a computer device is illustrated. The memory 901 includes at least one type of the computer-readable storage medias, which includes a flash memory, a hard disk, a multimedia card, a card type storage (for example, an SD or a DX storage, etc.), a magnetic storage, a disks, a optical disks, etc. The memory 901 may in some embodiments be an internal storage unit of a computer device 900, such as the hard disk of the computer device. The memory 901 may also be an external storage device of a computer device 900 in other embodiments, such as a plug-in hard disk, a Smart Media Card (SMC), a Secure Digital Card (SD), a Flash Card, etc., equipped on a computer device 900. Furthermore, the memory 901 may include both the internal storage unit of the computer device 900 and the external storage device. The memory 901 can not only be used to store the application software and all kinds of data installed in the computer device 900, such as the program instruction of the training method for the multi-task recognition network based on end-to-end, but also can be used to temporarily store the data that has been output or will be output, such as the data generated by the implementation of the training method for the multi-task recognition network based on end-to-end. For example, the data includes the 2D image samples 11, the 3D image samples 12, the radar bird's-eye-view samples 13 and the lidar bird's-eye-view samples 14, etc.

The processor 902 may in some embodiments be a central processing unit (CPU), a controller, a microcontroller, a microprocessor, or other data processing chip for running the program instruction stored in the memory 901 or for processing data. Specifically, the processor 902 executes the program instruction of the training method for the multi-task recognition network based on end-to-end to control the computer device 900 to realize the training method for the multi-task recognition network based on end-to-end.

Furthermore, the computer device 900 may include a bus 903, which may be a peripheral component interconnect (PCI) standard bus, or an extended industry standard architecture (EISA) bus. The bus can be divided into an address bus, a data bus, a control bus and so on. For ease of presentation, only a thick line is shown in FIG. 8, but this does not mean that there is only one bus or one type of buses.

Furthermore, the computer device 900 may include a display component 904. The display component 904 can be a light emitting diode (LED) display, a LCD, a touch LCD and an organic light-emitting diode (OLED) touch device. The display component 904, which may also be appropriately referred to as a display device or a display unit, is used to display the information processed in the computer device 900 as well as the user interface for displaying the visualization.

Furthermore, the computer device 900 can also include a communication component 905, which can optionally include a wired communication component and/or a wireless communication component (such as a Wi-Fi communication component, a bluetooth communication component, etc.), usually used to establish a communication connection between the computer device 900 and other computer devices.

FIG. 8 only shows the computer device 900 with components 901-905 and the program instruction for implementing the training method for the multi-task recognition network based on end-to-end. It is understood by those skilled in the field that the structure shown in FIG. 8 does not constitute a limitation to the computer device 900 and may include fewer or more parts than the figure, or combine some parts. Or different arrangement of components. Since the computer device 900 adopts all the technical solutions of all the above embodiments, it has at least all the beneficial effects brought about by the technical solutions of the above embodiments and will not be repeated here.

In the above embodiments, may be implemented in whole or in part by software, hardware, firmware, or any combination thereof. When implemented using software, it can be implemented in whole or in part in the form of a computer program product. The technical personnel in the field can clearly understand that, for the convenience and conciseness of description, the specific working process of the system, device and unit described above can refer to the corresponding process in the above embodiment of the method, and will not be repeated here.

In the embodiments provided in the present invention, it should be understood that the disclosed systems, devices and methods can be implemented by other means. For example, the training method for a multi-task recognition network based on end-to-end described above is only schematic. For example, the division of the unit is only a logical function division. In actual implementation, there may be other division ways, for example, multiple units or components can be combined or integrated into another system, or some features can be ignored or not performed. On the other hand, the coupling or direct coupling or communication connection between each other shown or discussed may be indirect coupling or communication connection through some interface, device or unit, and may be electrical, mechanical or other.

It should be noted that the embodiments number of this invention above is for description only and do not represent the advantages or disadvantages of embodiments. And in this invention, the term “including”, “include” or any other variants is intended to cover a non-exclusive contain. So that the process, the devices, the items, or the methods includes a series of elements not only include those elements, but also include other elements not clearly listed, or also include the inherent elements of this process, devices, items, or methods. In the absence of further limitations, the elements limited by the sentence “including a . . . ” do not preclude the existence of other similar elements in the process, devices, items, or methods that include the elements.

The above disclosed preferred embodiments of the invention are intended only to assist in the elaboration of the invention. The preferred embodiment does not elaborate on all the details and does not limit the invention to a specific embodiment. Obviously, according to the contents of this instruction manual, a lot of amendments and changes can be made. These embodiments are selected and described in detail in this specification for the purpose of better explaining the principle and practical application of the invention, so that the technical personnel in the technical field can better understand and utilize the invention. The invention is limited only by the claims and their full scope and equivalents.

The above are only the preferred embodiments of this invention and do not therefore limit the patent scope of this invention. And equivalent structure or equivalent process transformation made by the specification and the drawings of this invention, either directly or indirectly applied in other related technical fields, shall be similarly included in the patent protection scope of this invention.

1. A training method for a multi-task recognition network based on end-to-end, comprising:
obtaining a plurality of data and location information by a plurality of different sensors, the plurality of different sensors comprising a 2D camera, a 3D camera, a radar, and/or a lidar located at different positions of an autonomous driving vehicle;
inputting the plurality of data into a corresponding data processing network to obtain a plurality of first samples, each of the first samples comprising a 2D image sample, a 3D image sample, a radar bird's-eye-view sample, and/or a lidar bird's-eye-view sample;
inputting the first samples into a feature extraction network to obtain a plurality of first-sample features;
inputting the plurality of the first-sample features and the plurality of location information into a feature recognition network to obtain a plurality of second samples, each of the second samples comprising a target object, and a motion trajectory of the target object at a current position contained in the plurality of data; and
training an initial multi-task recognition network based on the second samples to obtain a target multi-task recognition network with recognition and prediction functions.

2. The training method for the multi-task recognition network of claim 1, wherein inputting the plurality of data into the corresponding data processing network to obtain the plurality of first samples further comprises:
inputting the data obtained from the 2D camera into a first convolutional neural network to obtain the 2D image sample;
inputting the data obtained from the 3D camera into a second convolutional neural network to obtain the 3D image sample;
inputting the data obtained from the radar into a third convolutional neural network to obtain the radar bird's-eye-view sample; and
inputting the data obtained from the lidar into a fourth convolutional neural network to obtain the lidar bird's-eye-view sample.

3. The training method for the multi-task recognition network of claim 1, wherein the feature recognition network comprises a plurality of recognition sub-neural networks and a plurality of prediction sub-neural networks; inputting the plurality of the first-sample features and the plurality of location information into a feature recognition network to obtain the plurality of the second samples further comprises:
selecting the recognition sub-neural networks and the prediction sub-neural networks from the plurality of recognition sub-neural networks and the plurality of prediction sub-neural networks correspondingly according to the plurality of location information;
inputting the first-sample features into the selected recognition sub-neural networks to obtain the target object; and
inputting the first-sample features and the data of a 3D high-precision map at the current position into the selected predictive sub-neural networks to obtain the motion trajectory of the target object at the current position.

4. The training method for the multi-task recognition network of claim 1, wherein the feature extraction network is a transformer neural network.

5. The training method for the multi-task recognition network of claim 1, wherein the feature recognition network is a spacial recurrent neural network.

6. The training method for the multi-task recognition network of claim 1, wherein the initial multi-task recognition network is a multilayer perceptron.

7. A prediction method for road targets and target behaviors, comprising:
obtaining a plurality of data and location information by a plurality of different sensors, the plurality of different sensors comprising a 2D camera, a 3D camera, a radar, and/or a lidar located at different positions of an autonomous driving vehicle; and
inputting the plurality of data and location information into a target multi-task recognition network of the training method for a multi-task recognition network based on end-to-end to obtain a target object, and a motion trajectory of the target object contained in the plurality of data, the training method comprising:
obtaining a plurality of data and location information by a plurality of different sensors, the plurality of different sensors comprising a 2D camera, a 3D camera, a radar, and/or a lidar located at different positions of an autonomous driving vehicle;
inputting the plurality of data into a corresponding data processing network to obtain a plurality of first samples, each of the first samples comprising a 2D image sample, a 3D image sample, a radar bird's-eye-view sample, and/or a lidar bird's-eye-view sample;
inputting the first samples into a feature extraction network to obtain a plurality of first-sample features;
inputting the plurality of the first-sample features and the plurality of location information into a feature recognition network to obtain a plurality of second samples, each of the second samples comprising a target object, and a motion trajectory of the target object at a current position contained in the plurality of data; and
training an initial multi-task recognition network based on the second samples to obtain a target multi-task recognition network with recognition and prediction functions.

8. The prediction method of claim 7, wherein inputting the plurality of data into the corresponding data processing network to obtain the plurality of first samples further comprises:
inputting the data obtained from the 2D camera into a first convolutional neural network to obtain the 2D image sample;
inputting the data obtained from the 3D camera into a second convolutional neural network to obtain the 3D image sample;
inputting the data obtained from the radar into a third convolutional neural network to obtain the radar bird's-eye-view sample; and
inputting the data obtained from the lidar into a fourth convolutional neural network to obtain the lidar bird's-eye-view sample.

9. The prediction method of claim 7, wherein the feature recognition network comprises a plurality of recognition sub-neural networks and a plurality of prediction sub-neural networks; inputting the plurality of the first-sample features and the plurality of location information into a feature recognition network to obtain the plurality of the second samples further comprises:
selecting the recognition sub-neural networks and the prediction sub-neural networks from the plurality of recognition sub-neural networks and the plurality of prediction sub-neural networks correspondingly according to the plurality of location information;
inputting the first-sample features into the selected recognition sub-neural networks to obtain the target object; and
inputting the first-sample features and the data of a 3D high-precision map at the current position into the selected predictive sub-neural networks to obtain the motion trajectory of the target object at the current position.

10. The prediction method of claim 7, wherein the feature extraction network is a transformer neural network.

11. The prediction method of claim 7, wherein the feature recognition network is a spacial recurrent neural network.

12. The prediction method of claim 7, wherein the initial multi-task recognition network is a multilayer perceptron.

13. A computer device, the computer device comprising:
a memory, configured to store a program instruction; and
a processor, configured to execute the program instruction to perform a training method for a multi-task recognition network based on end-to-end, the training method for a multi-task recognition network based on end-to-end comprising:
obtaining a plurality of data and location information by a plurality of different sensors, the plurality of different sensors comprising a 2D camera, a 3D camera, a radar, and/or a lidar located at different positions of an autonomous driving vehicle;
inputting the plurality of data into a corresponding data processing network to obtain a plurality of first samples, each of the first samples comprising a 2D image sample, a 3D image sample, a radar bird's-eye-view sample, and/or a lidar bird's-eye-view sample;
inputting the first samples into a feature extraction network to obtain a plurality of first-sample features;
inputting the plurality of the first-sample features and the plurality of location information into a feature recognition network to obtain a plurality of second samples, each of the second samples comprising a target object, and a motion trajectory of the target object at a current position contained in the plurality of data; and
training an initial multi-task recognition network based on the second samples to obtain a target multi-task recognition network with recognition and prediction functions.

14. The computer device of claim 13, wherein inputting the plurality of data into the corresponding data processing network to obtain the plurality of first samples further comprises:
inputting the data obtained from the 2D camera into a first convolutional neural network to obtain the 2D image sample;
inputting the data obtained from the 3D camera into a second convolutional neural network to obtain the 3D image sample;
inputting the data obtained from the radar into a third convolutional neural network to obtain the radar bird's-eye-view sample; and
inputting the data obtained from the lidar into a fourth convolutional neural network to obtain the lidar bird's-eye-view sample.

15. The computer device of claim 13, wherein the feature recognition network comprises a plurality of recognition sub-neural networks and a plurality of prediction sub-neural networks; inputting the plurality of the first-sample features and the plurality of location information into a feature recognition network to obtain the plurality of the second samples further comprises:
selecting the recognition sub-neural networks and the prediction sub-neural networks from the plurality of recognition sub-neural networks and the plurality of prediction sub-neural networks correspondingly according to the plurality of location information;
inputting the first-sample features into the selected recognition sub-neural networks to obtain the target object; and
inputting the first-sample features and the data of a 3D high-precision map at the current position into the selected predictive sub-neural networks to obtain the motion trajectory of the target object at the current position.

16. The computer device of claim 13, wherein the feature extraction network is a transformer neural network.

17. The computer device of claim 13, wherein the feature recognition network is a spacial recurrent neural network.

18. The computer device of claim 13, wherein the initial multi-task recognition network is a multilayer perceptron.
